(19) United States
(12) Patent Application Publication
(10) Pub. No.: US 2024/0256659 A1
(43) Pub. Date: Aug. 1, 2024

(54) CONTAINER SECURITY IN A CLOUD ENVIRONMENT

(71) Applicant: Malwarebytes Inc., Santa Clara, CA (US)

(72) Inventors: Adam S. Hyder, Cupertino, CA (US); Thomas R. Gissel, Apex, NC (US); Motil Jayakar, Santa Clara, CA (US); Brian P. Morehead, Manteca, CA (US); Raghuram Sri Sivalanka, San Ramon, CA (US); Atanu Podder, Dublin, CA (US); Shoaib Ahmed Habib Ahmed Banikar, Maharashtra (IN)

(21) Appl. No.: 18/301,155

(22) Filed: Apr. 14, 2023

(30) Foreign Application Priority Data
Jan. 31, 2023 (IN) 202341006271

(51) Int. Cl. G06F 21/55; G06F 21/56; G06F 21/57

(52) U.S. Cl. CPC G06F 21/554; G06F 21/564; G06F 21/577

(57) ABSTRACT

An end-to-end container security system can detect vulnerabilities, track detected vulnerabilities, allow only verified images to run in production, detect behavioral anomalies in production containers, notify users of detected anomalies, notify users of policy violations, and/or take security actions to prevent or reduce harm.

### CROSS-REFERENCE TO RELATED APPLICATION

This application claims the benefit of Indian Patent Application No. 202341006271, filed Jan. 31, 2023, which is incorporated by reference.

### FIELD OF ART

The present disclosure relates generally to container workloads and, in particular, to detection and classification of anomalous behavior of container workloads in a cloud-based environment.

### BACKGROUND

When a container workload is run in a cloud or data center environment, it is difficult to know what the workload is doing. It could be running bit-mining operations, transferring personal identifiable information by fetching from a database, or gathering confidential data and sending it over the internet to a third party, etc. This occurs because developers typically take container images from third-party providers and deploy them directly within their environments. These images can have intentional or unintentional security flaws and vulnerabilities that can be exploited when they are run in the cloud and data center environments.

### SUMMARY

The above and other problems may be addressed by a container security system that detects security vulnerabilities and threats at various stages in the creation and deployment of containers. In various embodiments, an end-to-end container security system can detect vulnerabilities, track detected vulnerabilities, allow only verified images to run in production, detect behavioral anomalies in production containers, notify users of detected anomalies, notify users of policy violations, and/or take security actions to prevent or reduce harm.

The container security system can include one or more of a container image vulnerability management module, a cloud security posture management module, a cloud detection and response module, and an intelligent watchdog action engine. The container image vulnerability management module tests images in a sandbox environment and records the behavior of the container. Images that are verified in the sandbox environment as meeting required security standards are authorized for use in production. The cloud security posture management module monitors the use and configuration of networked resources for compliance with best practices and policies. The cloud detection and response module monitors the behavior of deployed containers and identifies anomalies by comparing that behavior to previously recorded behavior for the corresponding image. Detected anomalies are analyzed and, where appropriate, security actions are taken. The intelligent watchdog action engine aggregates threat intelligence across multiple containers to identify and address threats.

In one embodiment, the container security system receives behavior data describing activities of a deployed container that was created using a container image. The container security system identifies test data describing activities of a test container created using the same container image in a sandbox environment. Based on a comparison of the behavior data and the test data, the container security system detects an anomaly in the activities of the deployed container and determines whether the detected anomaly is associated with a malicious activity. The container security system may perform various security actions depending on whether the detected anomaly is associated with malicious activity and the nature of the malicious activity. For example, if the anomaly is not associated with malicious activity or is indicative of a potential future threat, rather than a current attack, then the container security system may generate a notification of the anomaly for display to a user (e.g., a network administrator responsible for the deployed container). In contrast, if the anomaly is determined to be associated with an imminent attack or security breach, the deployed container may be deleted, quarantined, or otherwise disabled.

### BRIEF DESCRIPTION OF THE DRAWINGS

FIG. 1 is a block diagram of a networked computing environment in which containers may be tested and deployed, according to an embodiment.

FIG. 2 is a block diagram of an example cloud environment from FIG. 1, according, according to an embodiment.

FIG. 3 is a block diagram of the container security system of FIG. 1, according, according to an embodiment.

FIG. 4 is a flowchart illustrating an example process for detecting and addressing anomalous behavior of a container, according to an embodiment.

FIG. 5 is a block diagram illustrating components of an example machine able to read instructions from a machine-readable medium and execute them in a processor (or controller), according to an embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Configuration Overview

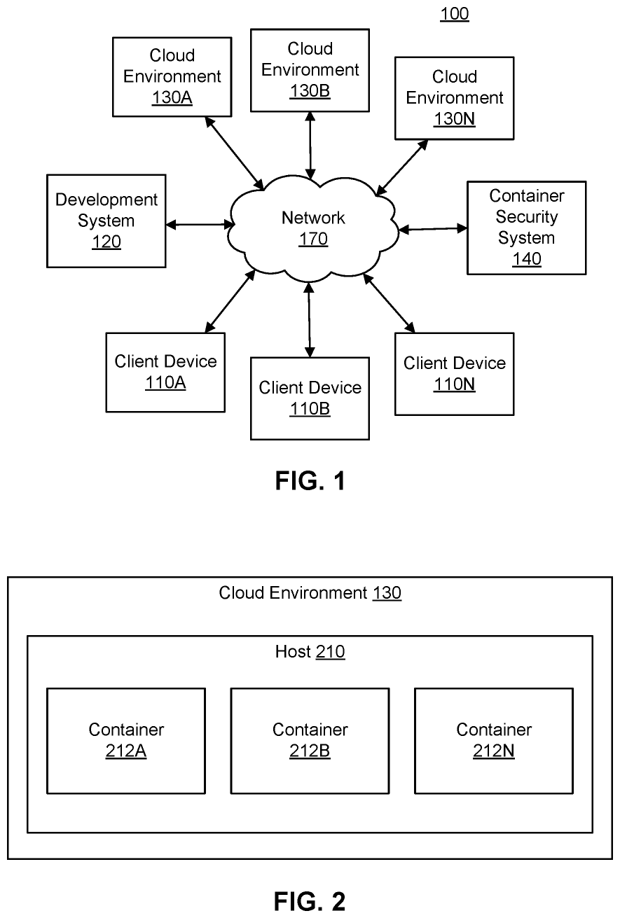

Figure (FIG. 1 illustrates one embodiment of a networked computing environment 100 in which containers can be tested and deployed. In the embodiment shown, the networked computing environment 100 includes one or more client devices 110A-N, a development system 120, one or more cloud environments 130A-N, and a container security system 140, all connected via a network 170. For simplicity and clarity, only three client devices 110 (a first client device 110A, second client device 110B, and Nth client device 110N), one development system 120, three cloud environments 130 (a first cloud environment 130A, second cloud environment 130B, and Nth cloud environment 130N), and one container security system 140 are shown, but in practice the networked computing environment may include any number of each element. In other embodiments, the networked computing environment includes different or additional elements. In addition, the functions may be distributed among the elements in a different manner than described. For example, although the development system 120 and container security system 130 are shown as distinct elements, some or all of the functionality attributed to each may be provided by the same computing system.

A client device 110 may be any computing device with which a user (e.g. a developer) defines, tests, deploys, or uses a container or container image. A container image is a static file with executable code that may be used to create a container on a computing system. The user of container images enables deployment of containers with the same functionality consistently in different environments.

The development system 120 is one or more computing devices that provide functionality for development and deployment of containers. In one embodiment, the development system 120 provides a code repository. Developers may use client devices 110 to upload container images (and other code) to the code repository. The development system 120 may provide continuous integration and continuous deployment (CI/CD) functions to enable rapid deployment of incremental updates to the container images. Developers may deploy containers by using corresponding container images to creates instances of the container on a target computing system (e.g, within a cloud environment 130).

The cloud environments 130 may be datacenters, enterprise clouds, or any other networked environment in which containers may be deployed. A cloud environment 130 typically includes numerous computing devices operating in conjunction via a network (e.g., network 170), but in some instances may be provided by a single computing device. Similarly, a cloud environment 130 is typically managed for or by a single entity, such as an enterprise or other institution, but in some cases may be shared by multiple entities or public. An example cloud environment is described in greater detail below, with reference to FIG. 2.

The container security system 140 provides security functionality for the container images stored in the development system 120 as well as corresponding containers that are deployed in production (e.g., in a cloud environment 130). In one embodiment, when a container image is created or modified in the development system 120, the container security system 140 creates a test container from the container image in a sandbox environment for testing. The testing may include identifying know vulnerabilities and threats as well as evaluating the behavior of the container for unknown vulnerabilities. The container security system 140 saves behavioral data describing the activities of the container in the sandbox environment.

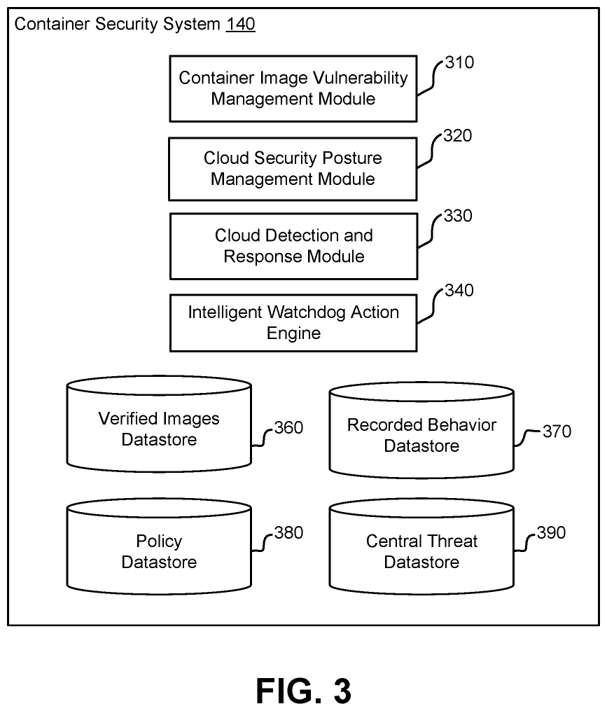

The container security system 140 may also monitor the behavior of deployed containers (e.g., in the cloud environments 130). In one embodiment, the container security system compares the behavior of deployed containers to the recorded behavior of the corresponding test container in the sandbox environment to identify anomalies. The container security system 140 may further determine whether a detected anomaly is associated with malicious behavior and take one or more appropriate security actions depending on the nature of the anomaly. Various embodiments of the container security system 140 are described in greater detail below, with reference to FIG. 3.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

### Example Systems

FIG. 2 illustrates one embodiment of a cloud environment 130. In the embodiment shown, the cloud environment 130 includes a host 210 that is running a set of one or more containers 212 (in this case, a first container 212A, a second container 212B, and an Nth container 212N). In other embodiments, the cloud environment 130 includes different or additional elements. In addition, the functions may be distributed among the elements in a different manner than described.

The cloud environment 130 may be operated by or for an entity (e.g., an enterprise). For example, a cloud services provider may provide a set of hosts 210 to which the entity may deploy containers 212. Use of the cloud environment 130 may be controlled by one or more policies that limit access to the hosts 210 and/or containers 212 to users with appropriate credentials (e.g., issued by the entity).

A host 210 is a computing device capable of running one or more containers 212. Although FIG. 2 only includes a single host 210 for simplicity, a cloud environment 130 may include any number of hosts 210 and will typically include numerous hosts. The containers 212 provide functionality to users associated with the entity and may be created from one or more container images that have been verified by the container security system 140. The container security system 140 may also monitor the containers 212 for anomalous behavior and take appropriate security actions on detecting anomalies.

FIG. 3 illustrates one embodiment of the container security system 140. In the embodiment shown, the container security system 140 includes a container image vulnerability management module 310, a cloud security posture management module 320, a cloud detection and response module 330, an intelligent watchdog action engine 340, a verified images datastore 360, a recorded behavior datastore 370, a policy datastore 380, and a central threat datastore 390. In other embodiments, the container security system 140 includes different or additional elements. In addition, the functions may be distributed among the elements in a different manner than described. For example, although the container security system 140 is shown as a single entity, the described functionality may be split across multiple entities (e.g., one system may verify and provide container images while another may monitor the behavior of deployed containers).

The container image vulnerability management module 310 valuates new or modified container images to identify security risks. The container image vulnerability management module 310 may be integrated into a software supply chain or CI/CD pipeline. For example, when container images are built from a repository in the development system 120, the container image vulnerability management module 310 may first create a container from the container image in a sandbox environment and verify that the behavior of container in the sandbox environment is unlikely to correspond to a security risk.

The sandbox environment is an isolated and secure environment that includes an emulator for emulating and monitoring behavior of a test container created from a container image. The container image vulnerability management module 310 uses the sandbox environment to control and monitor the resources to which the test container has access during testing. The container image vulnerability management module 310 can follow the execution of each instruction executed by the test container as it is executed in the sandbox environment and record the activity of the test container as test activity data (also referred to as just “test data”). The recorded test data can include all actions, data traffic, network traffic, interaction and access to internal and external resources, CPU usage, memory usage, and disk usage, etc. of the test container in the sandbox environment. The container image vulnerability management module 310 may store the test data (e.g., in the recorded behavior datastore 370).

The container image vulnerability management module 310 may determine from the behavior of the test container whether container image meets one or more security criteria. In one embodiment, container image vulnerability management module 310 applies one or more tests to determine whether the container image meets the security criteria. The tests may include comparing the behavior of the test container to definitions of one or more known vulnerabilities. The tests may also include one or more heuristic analyses that identify previously unknown vulnerabilities or malicious behavior. It should be appreciated that a wide range of tests may be performed to determine whether the container image meets various security criteria and can be considered safe for deployment.

Assuming that the container image meets the security criteria, the container image vulnerability management module 310 stores the container image as a verified container image (e.g., in the verified images datastore 360). Alternatively, the container image vulnerability management module 310 may tag the container image as verified in a datastore where it is already stored. If a container image does not meet the security criteria, an appropriate user (e.g., the responsible developer) may be notified and, where appropriate, provided with suggestions for how to address the identified security risk. The container image vulnerability management module 310 may prevent unverified container images from being deployed or provide warnings to users who attempt to deploy unverified container images (e.g., depending on a severity of the detected security risk that prevented verification). Thus, the container image vulnerability management module 310 can reduce the risk that container images that are not pristine, verified, and secure are deployed.

The cloud security posture management module 320 monitors resources such as servers, storage, databases, networks, containers, and other resources in the cloud environments 130. In one embodiment, system administrators of cloud environments 130 may set policies and the cloud security posture management module 320 monitors the behavior of containers (and other resources) for compliance with these policies. The cloud security posture management module 320 may make recommendations or configuration changes so that the monitored resources are hardened and configured to be accessed only by authorized resources based on best practices and any policies set by the relevant system administrators. If a container (or other resource) violates a set policy (or a change in set policy would result in a container no longer being compliant with the policy), then the cloud security posture management module 320 may generate a notification for display to the relevant system administrator. In some instances, the cloud security posture management module 320 may take other security actions, such as quarantining or otherwise disabling access to a container until a potential policy violation has been reviewed by a system administrator.

The cloud detection and response module 330 monitors activities of deployed containers to detect potentially malicious activities. In various embodiments, the cloud detection and response module 330 collects behavior data by monitoring the activities of the deployed container at the lowest level of the operating system. The behavioral data and sequence of events may be analyzed to detect suspicious activities. In one such embodiment, the cloud detection and response module 330 looks for suspicious activities by comparing observed activities of a deployed container image with previously recorded activities of a test container and/or one or more other deployed containers created from the same container image to detect anomalies between runs. An anomaly is a difference between the activities of the deployed container and the previously recorded activities, which may be indicative of malicious behavior.

The cloud detection and response module 330 may determine the seriousness of detected anomalies. In one embodiment, the cloud detection and response module 330 classifies anomalies into predetermined categories (e.g., serious and non-serious). Alternatively, the cloud detection and response module 330 may assign risk scores to detected anomalies indicating a likelihood that the corresponding anomaly is associated with malicious behavior. The anomaly may include one or more behavioral violations or one or more anomalous activities. In some embodiments, the anomaly may include a new activity or a modified activity of container. For example, the cloud detection and response module 330 may discover a new activity in the container image that is not previously recorded for the corresponding storage object. The cloud detection and response module 330 may determine this new/modified activity as an anomaly and further determine whether the anomaly is associated with a malicious activity, such as, accessing a known malicious web address, violating a policy, or otherwise exhibiting malware-like behavior, etc.

To determine whether an anomaly is associated with malicious behavior, the cloud detection and response module 330 may compare at least a portion of the activities of the container image to a database of legitimate activities. For example, external calls to a common DNS server or service provider may be considered low risk of being associated with malicious behavior and classified as non-serious. The cloud detection and response module 330 may also compare at least a portion of the activities of the container image to a database of known malicious activities, e.g., accessing a web address known to associated with historically malicious behavior. If the comparison yields a match, the cloud detection and response module 330 may determine that the corresponding activity represents a high risk of being associated with malicious behavior and classify the anomaly as serious.

In some cases, the anomaly may include one or more behavioral violations. The cloud detection and response module 330 may perform an analysis of each behavioral violation and each analysis may output a likelihood that the behavioral violation is associated with a malicious activity. The cloud detection and response module 330 may further combine the likelihoods of all detected behavioral violations to produce a combined likelihood/score to determine whether the container is exhibiting malicious behavior.

In some implementations, the cloud detection and response module 330 may determine whether a container is malicious based on a pattern of anomalies. For example, a single external call to an unknown web address may be deemed a non-serious anomaly, but a pattern of calls to unknown web addresses may match a known pattern associated with malicious activity (e.g., a pattern associated with bitcoin mining). In this way, the cloud detection and response module 330 may monitor activities of a container at an aggregated level and detect a malicious behavior pattern over time.

The cloud detection and response module 330 may take one or more security actions in response to detected anomalies. These security actions can range from deleting or quarantining the container to providing a notification for display to an appropriate user (e.g., a system administrator responsible for the container) providing information regarding the detected anomaly and any potentially associated malicious behavior. For example, if the cloud detection and response module 330 detects behavior that is highly likely to be an on-going security breach by a malicious party, the container may be immediately deleted or quarantined. In contrast, if the anomaly is classified as non-serious, then the cloud detection and response module 330 may just generate a notification. It should be appreciated that a wide range of security actions are possible, depending on the nature and seriousness of the detected anomaly.

The intelligent watchdog action engine 340 provides a “big picture” view of activities across multiple containers. The intelligent watchdog action engine 340 may aggregate behavioral data from all of the containers in a single cloud environment 130 or from containers in multiple cloud environments (e.g., all cloud environments that have elected to use the intelligent watchdog engine 340). The aggregated behavioral data may be stored in a central repository (e.g., the central threat datastore 390). The central repository may also store other information, such as threat intelligence data regarding attacks and security breaches on containers.

In one embodiment, the intelligent watchdog action engine 340 tracks behavioral anomalies and policy violations at multiple run-time levels, including cloud, host, virtual environment, and container for the individual as well as at the aggregate level to determine coordinated attacks and correlate across factors such as region, industry, cloud provider, types of container workload, types of attacks, and types of malicious activities to provide herd protection mechanisms and properties. For example, on detecting that multiple containers created from a container image operated by several entities in a particular industry have been attacked in the same way, the intelligent watchdog engine 340 may proactively take action to protect containers associated with other entities in the same industry (e.g., by propagating updates, providing notifications, changing policies, quarantining containers, and the like). The intelligent watchdog action engine 340 may also track outside activities such as brute-force attacks on the host and provide feedback to all other modules.

The intelligent watchdog engine 340 may apply artificial intelligence/machine learning (AI/ML) to predict containers that are at-risk of future attacks. In one embodiment, the intelligent watchdog engine 340 uses AI/ML based pattern detection, entity and workload segmentation, and/or behavioral analysis to identify containers of entities that have not yet been attacked but that are potentially vulnerable to or likely targets of an attack in future. The intelligent watchdog engine 340 may provide feedback to the other modules of the container security system 140 so that appropriate security actions may be taken to block the predicted future attacks. For example, a previously verified container image that includes a security vulnerability may ne unverified until the vulnerability is fixed, an access policy may be updated, a deployed container may be suspended, or the like.

The verified images datastore 360, recorded behavior datastore 370, policy datastore 380, and central threat datastore 390 each include one or more computer-readable media that store data. The data stored by the verified images datastore 360 includes a repository of verified container images. The data stored by the recorded behavior datastore 370 includes test data describing the behavior of containers in the sandbox environment during testing. The data stored by the policy datastore 380 includes copies of policies set for the cloud environments 130. The data stored by the central threat datastore 390 includes aggregated behavior data from a fleet of containers (potentially across multiple cloud environments 130). The datastores may be in local or cloud storage. Although the datastores are shown as distinct entities, is some embodiments, some or all of the datastores may be combined into a single datastore. Furthermore, one or more of the datastores may be split into two or more parts that are stored separately.

### Example Methods

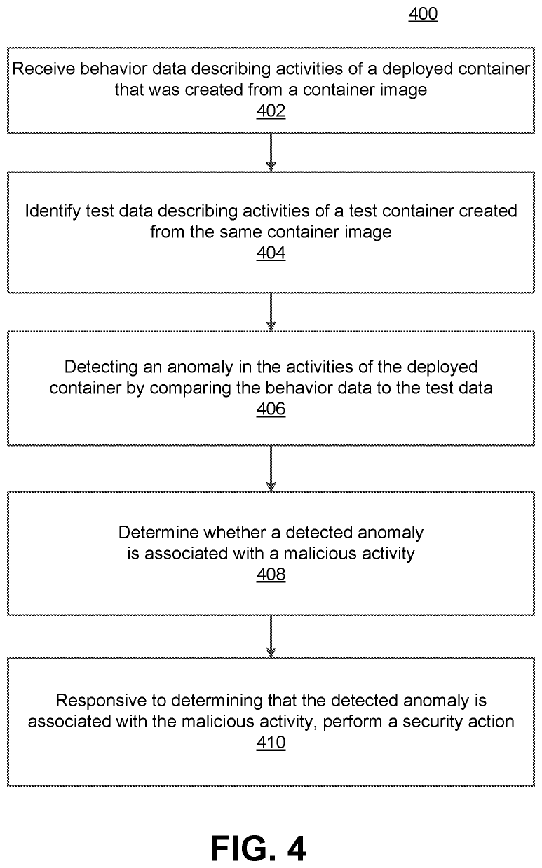

FIG. 4 is a flowchart illustrating an example process 400 for detecting and addressing anomalous behavior of a container, according to an embodiment. The steps of FIG. 4 are illustrated from the perspective of the container security system 140 performing the method 400. However, some or all of the steps may be performed by other entities or components. In addition, some embodiments may perform the steps in parallel, perform the steps in different orders, or perform different steps.

In the embodiment shown in FIG. 4, the process 400 begins with the container security system 140 receiving 402 behavior data describing activities of a deployed container that was created from a container image. For example, the cloud environment 130 in which the container is deployed may periodically provide telemetry including behavior data to the container security system 140. The behavior data may indicate actions, data traffic, network traffic, interaction and access to internal and external resources, CPU usage, memory usage, and/or disk usage, etc., of the deployed container. The container security system 140 identifies 404 test data describing activities of a test container created from the same container image as the deployed container. The test data may include data generated in a sandbox environment by a test container and/or data generated by other deployed containers created from the same container image.

The container security system 140 detects 406 an anomaly in the activities of the deployed container by comparing the behavior data to the test data. For example, the container security system 140 may compare activities of the deployed container with previously recorded activities of the test container to identify differences (i.e., anomalies). The container security system 140 determines 408 whether the detected anomaly is associated with a malicious activity. A malicious activity may include accessing a known malicious website, accessing a restricted area of memory, violating a policy of a client server, performing bitcoin mining, leaking confidential data, and the like. The container security system 140 may use a set of rules, a machine learning model, or both to classify the detected anomaly. As described previously, the detected anomaly may be classified into one of a set of predetermined categories, assigned a risk score of being associated with malicious behavior, or both.

Responsive to determining that the detected anomaly is associated with the malicious activity, the container security system 140 performs 410 a security action. The security action may include one or more of deleting the container, quarantining the container, suspending operations of the container, modifying access permissions of the container, or generating a notification for display to a user associated with the container (e.g., a system administrator). The nature of the security action taken may depend on the nature of the malicious activity (or absence of malicious activity). For example, if an on-going serious attack is detected, the container may be deleted or quarantined while suspicious behavior that does not appear to be an immediate threat may be flagged for review by a user via a notification.

### Computing System Architecture

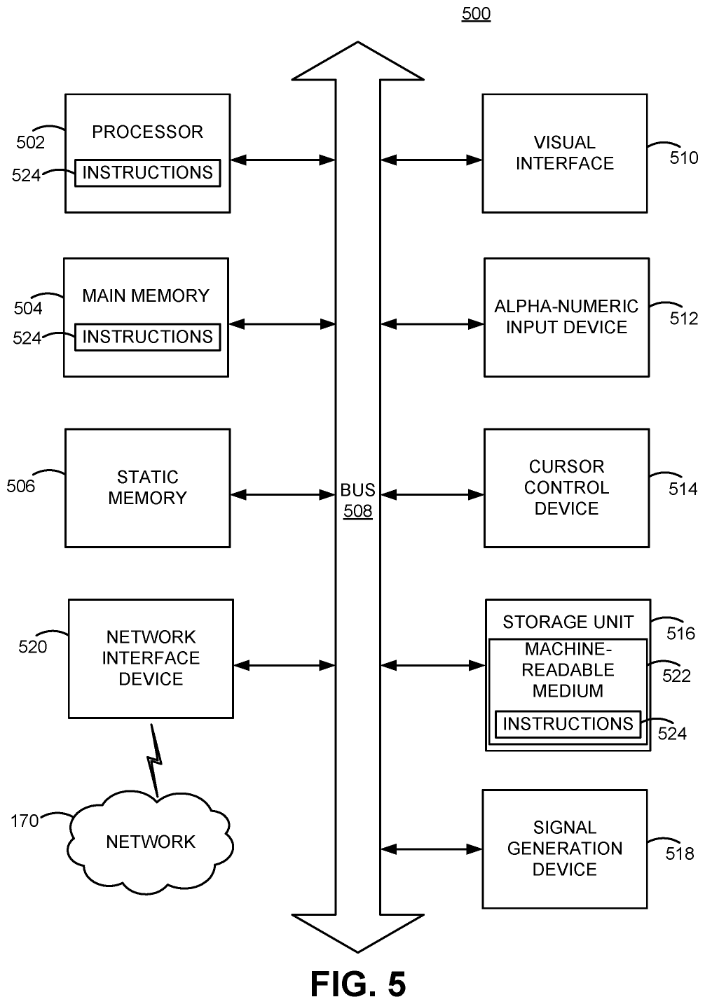

FIG. 5 is a block diagram illustrating components of an example machine able to read instructions from a machine-readable medium and execute them in a processor (or controller), according to an embodiment. Specifically, FIG. 5 shows a diagrammatic representation of a machine in the example form of a computer system 500 within which program code (e.g., software) for causing the machine to perform any one or more of the methodologies discussed herein may be executed. The program code may be comprised of instructions 524 executable by one or more processors 502. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a tablet, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include visual display interface 510. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 510 may include or may interface with a touch enabled screen. The computer system 500 may also include alphanumeric input device 512 (e.g., a keyboard or touch screen keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described in this disclosure. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network (e.g., network 170) via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for managing the security of containers that execute in a cloud-based environment. Thus, while particular embodiments and applications have been illustrated and described, it is to be understood that the described subject matter is not limited to the precise construction and components disclosed. The scope of protection should be limited only by the following claims.

What is claimed is:

1. A non-transitory computer-readable medium comprising stored instructions that, when executed by a computing system, cause the computing system to perform operations including:
receiving behavior data describing activities of a deployed container, the deployed container having been created using a container image;
identifying test data describing activities of a test container, the test container having been created using the container image;
detecting, based on a comparison of the behavior data and the test data, an anomaly in the activities of the deployed container;
determining whether the detected anomaly is associated with a malicious activity; and
responsive to the determination of whether the detected anomaly is associated with the malicious activity, performing a security action.

2. The non-transitory computer-readable medium of claim 1, wherein the operations further include:
receiving, from a client device, the container image;
creating the test container in a sandbox environment using the container image;
running the test container in the sandbox environment to generate the test data;
verifying the container image using the test data; and
responsive to verifying the container image, adding the container image to a verified images store, wherein creating the deployed container included retrieving the container image from the verified images store.

3. The non-transitory computer-readable medium of claim 2, wherein verifying the container image comprises:
comparing the activities of the test container to a database of known malicious activities; and
verifying the container image responsive to the activities of the test container not corresponding to know malicious activities.

4. The non-transitory computer-readable medium of claim 2, wherein verifying the container image comprises:
analyzing the test data to determine whether any of the activities of the test container correspond to previously unknown malicious behavior; and
verifying the container image responsive to none of the of the activities of the test container corresponding to previously unknown malicious behavior.

5. The non-transitory computer-readable medium of claim 1, wherein the malicious activity comprises accessing a known malicious web address or accessing a restricted area of memory.

6. The non-transitory computer readable medium of claim 1, wherein the operations further comprise:
inputting the behavior data of the deployed container into a machine learning model, the machine learning model trained to identify security threats using additional behavior data of other deployed containers; and
receiving, as an output from the machine learning model, a warning that the deployed container is vulnerable to an attack.

7. The non-transitory computer-readable medium of claim 1, wherein determining whether the detected anomaly is associated with a malicious activity comprises:
determining a classification of the detected anomaly; and
determining that the detected anomaly is associated with the malicious activity based on the classification.

8. The non-transitory computer-readable medium of claim 1, wherein the detected anomaly includes one or more behavioral violations, and determining whether the detected anomaly is associated with a malicious activity comprises:
analyzing the behavioral violations to generate, for each behavioral violation, a corresponding likelihood that the behavioral violation is associated with the malicious activity;
combining the corresponding likelihoods of the one or more behavioral violations to obtain a combined score; and
determine, based on the combined score, whether the anomaly is associated with the malicious activity.

9. The non-transitory computer-readable medium of claim 1, wherein the security action includes one or more of deleting the deployed container, quarantining the deployed container, suspending operations of the deployed container, or providing a notification of the anomaly for display to a user.

10. The non-transitory computer readable medium of claim 1, wherein the operations further include:
analyzing the behavior data to detect non-compliance of the deployed container with a policy of a cloud environment in which the deployed container is running; and
generating, responsive to detecting non-compliance of the deployed container with the policy, a notification for display to a user associated with the cloud environment.

11. A method comprising:
receiving behavior data describing activities of a deployed container, the deployed container having been created using a container image;
identifying test data describing activities of a test container, the test container having been created using the container image;
detecting, based on a comparison of the behavior data and the test data, an anomaly in the activities of the deployed container;
determining whether the detected anomaly is associated with a malicious activity; and
responsive to the determination of whether the detected anomaly is associated with the malicious activity, performing a security action.

12. The method of claim 11, further comprising:
receiving, from a client device, the container image;
creating the test container in a sandbox environment using the container image;
running the test container in the sandbox environment to generate the test data;
verifying the container image using the test data; and
responsive to verifying the container image, adding the container image to a verified images store, wherein creating the deployed container included retrieving the container image from the verfied images store.

13. The method of claim 12, wherein verifying the container image comprises:
comparing the activities of the test container to a database of known malicious activities; and
verifying the container image responsive to the activities of the test container not corresponding to know malicious activities.

14. The method of claim 12, wherein verifying the container image comprises:
analyzing the test data to determine whether any of the activities of the test container correspond to previously unknown malicious behavior; and
verifying the container image responsive to none of the of the activities of the test container corresponding to previously unknown malicious behavior.

15. The method of claim 11, further comprising:
inputting the behavior data of the deployed container into a machine learning model, the machine learning model trained to identify security threats using additional behavior data of other deployed containers; and
receiving, as an output from the machine learning model, a warning that the deployed container is vulnerable to an attack.

16. The method of claim 11, wherein determining whether the detected anomaly is associated with a malicious activity comprises:
determining a classification of the detected anomaly; and
determining that the detected anomaly is associated with the malicious activity based on the classification.

17. The method of claim 11, wherein the detected anomaly includes one or more behavioral violations, and determining whether the detected anomaly is associated with a malicious activity comprises:
analyzing the behavioral violations to generate, for each behavioral violation, a corresponding likelihood that the behavioral violation is associated with the malicious activity;
combining the corresponding likelihoods of the one or more behavioral violations to obtain a combined score; and
determine, based on the combined score, whether the anomaly is associated with the malicious activity.

18. The method of claim 11, wherein the security action includes one or more of deleting the deployed container, quarantining the deployed container, suspending operations of the deployed container, or providing a notification of the anomaly for display to a user.

19. The method of claim 11, further comprising:
analyzing the behavior data to detect non-compliance of the deployed container with a policy of a cloud environment in which the deployed container is running; and
generating, responsive to detecting non-compliance of the deployed container with the policy, a notification for display to a user associated with the cloud environment.

20. A container security system comprising:
one or more processors;
a container image vulnerability management module that, using the one or more processors:
generates test data describing activities of a test container, the test container having been created using a container image; and
verifies the container image responsive to the activities of the test container not corresponding to know malicious activities; and
a cloud detection and response module that:
receives behavior data describing activities of a deployed container, the deployed container having been created using the container image;
detects, based on a comparison of the behavior data and the test data, an anomaly in the activities of the deployed container;
determines whether the detected anomaly is associated with a malicious activity; and
responsive to the determination of whether the detected anomaly is associated with the malicious activity, performs a security action.
